(19) United States
(12) Patent Application Publication
(10) Pub. No.: US 2007/0226696 A1
(43) Pub. Date: Sep. 27, 2007

(54) System and method for the execution of multithreaded software applications

(75) Inventors: Ramesh Radhakrishnan, Austin, TX (US); Arun Rajan, Austin, TX (US)

Correspondence Address: Roger Fulghum;Baker Botts L.L.P., One Shell Plaza, 910 Louisiana Street, Houston, TX, 77002-4995, US

(73) Assignee: DELL PRODUCTS L.P.

(21) Appl. No.: 11/346,680

(22) Filed: Feb. 3, 2006

(51) Int. Cl. G06F 9/44

(52) U.S. Cl. 717/127

(57) ABSTRACT

A system and method is disclosed for optimizing the execution of a software application or other code. A computing environment may include a number of processing elements, each of which is characterized by one or more processors coupled to a single front side bus. The software application is subdivided into a number of functionally independent processes. Each process is related to a functional task of the software. Each functional process is then further subdivided on a data parallelism basis into a number of threads that are each optimized to execute on separate blocks of data. The subdivided threads are then assigned for execution to a processing element such that all of the subdivided threads associated with a functional process are assigned to a single processing element, which includes a single front side bus.

### TECHNICAL FIELD

The present disclosure relates generally to computer systems and information handling systems, and, more particularly, to a system and method for the execution of multithreaded software applications.

### BACKGROUND

As the value and use of information continues to increase, individuals and businesses seek additional ways to process and store information. One option available to these users is an information handling system. An information handling system generally processes, compiles, stores, and/or communicates information or data for business, personal, or other purposes thereby allowing users to take advantage of the value of the information. Because technology and information handling needs and requirements vary between different users or applications, information handling systems may vary with respect to the type of information handled; the methods for handling the information; the methods for processing, storing or communicating the information; the amount of information processed, stored, or communicated; and the speed and efficiency with which the information is processed, stored, or communicated. The variations in information handling systems allow for information handling systems to be general or configured for a specific user or specific use such as financial transaction processing, airline reservations, enterprise data storage, or global communications. In addition, information handling systems may include or comprise a variety of hardware and software components that may be configured to process, store, and communicate information and may include one or more computer systems, data storage systems, and networking systems.

A computer system or information handling system may include multiple processors and multiple front side buses (FSBs). Although each processor of the system will be coupled to one of the multiple front side buses, there could be conflict among the processors of the system for resources that must be shared by the processors of the system. One example of a resource that is shared by the multiple processors is cache resources. If, for example, shared data resides on a cache associated with a first processor and first front side bus, the operation of the system will be degraded by access or invalidate operations that must be performed by processors residing on a different front side bus.

### SUMMARY

In accordance with the present disclosure, a system and method is disclosed for optimizing the execution of a software application or other code. A computing environment may include a number of processing elements, each of which is characterized by one or more processors coupled to a single front side bus. The software application is subdivided into a number of functionally independent processes. Each process is related to a functional task of the software. Each functional process is then further subdivided on a data parallelism basis into a number of threads that are each optimized to execute on separate blocks of data. The subdivided threads are then assigned for execution to a processing element such that all of the subdivided threads associated with a functional process are assigned to a single processing element, which includes a single front side bus.

The system and method disclosed herein is technically advantageous because it reduces conflict and contention among and between the resources of the computing environment. Because the functionally distinct processes are separated among the processing elements, conflict among the processing element is minimized, as the necessity for a processor of a first processing element to access the resources of a processor of the second processing element is reduced. The system and method disclosed herein is also technically advantageous because the decomposed data threads are distributed among the processors of a single processing element, thereby placing in one processing element all of the software code, and the data required by the software code, that is likely to share the resources that are coupled to a single front side bus. Other technical advantages will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a diagram of a computing environment; and

FIG. 2 is a flow diagram of the method steps for subdividing software code into a number of threads and distributing those threads for execution among the processors of the computing environment.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communication with external devices as well as various input and output (I/O) devices, such as a keyboard, a mouse, and a video display. The information handling system may also include one or more buses operable to transmit communications between the various hardware components.

An information handling system or computer system may include multiple processors and multiple front side buses. Software that executes on the processors may execute across multiple processors according to one of two parallelism models. In a data decomposition model, a single function is threaded so that a single function is threaded to execute simultaneously and synchronously on two or more distinct blocks of data. The results of the simultaneous execution are later combined. Data decomposition is also known as data parallelism. The second model is known as functional decomposition and involves the execution of separate functional blocks on non-shared data in an asynchronous fashion. Functional decomposition is established and operates at a higher software level than data decomposition. Functional decomposition is also known as functional parallelism.

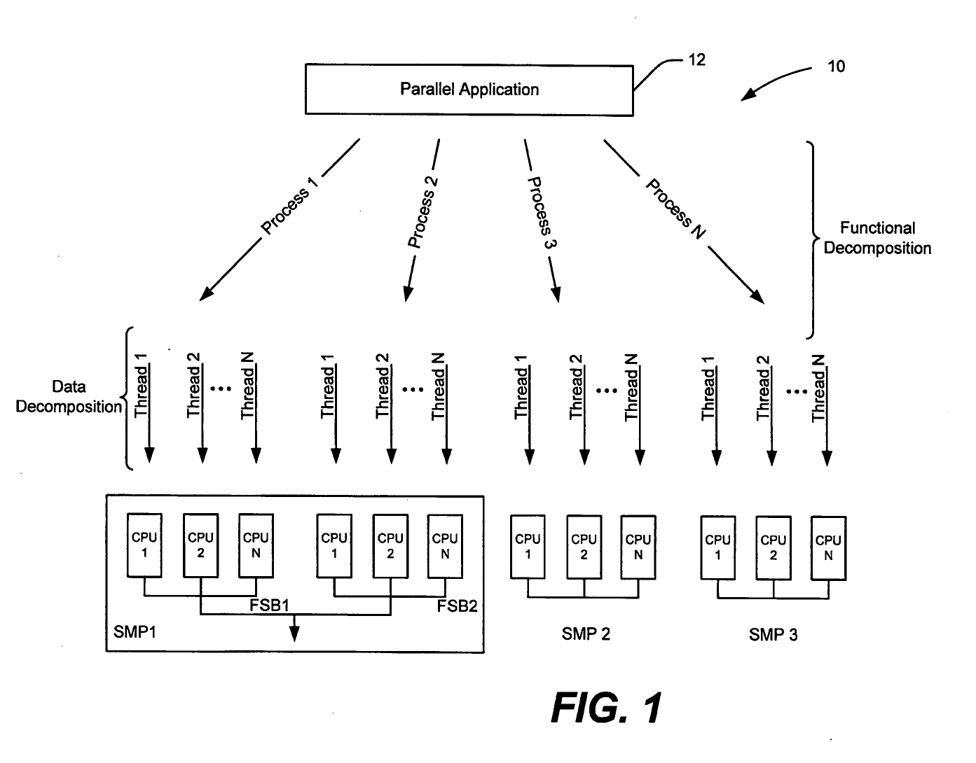

Shown in FIG. 1 is an example of a computing environment, which is indicated generally at 10. The computing environment 10 includes multiple symmetric multiple processor (SMP) systems, which are identified as SMP 1, SMP 2, and SMP 3. SMP 1 includes two front side buses, which are identified as FSB 1 and FSB 2. Each of the front side buses in SMP 1 are coupled to a plurality of processors, which are identified as CPU 1 through CPU N. SMP 2 and SMP 3 have only a single front side bus. Each of SMP 2 and SMP 3 includes multiple processors coupled to the front side bus of the system. Like SMP 1, the processors of SMP 2 and SMP 3 are labeled CPU 1 through CPU N.

A parallel application 12 executes in the computing environment 10. In operation, a compiler within the computing environment 10 separates the parallel application into multiple concurrent functional blocks, which are shown in FIG. 1 as processes and labeled as Process 1 through Process N. The step of separating the application into multiple functional processes is known as functional decomposition. Traditionally, functional decomposition occurs at the system level. Thus, a system with multiple front side buses will be assigned one functional task. As indicated in FIG. 1, each functional process is associated with a processing element that is comprised of a set of processors coupled to a single front side bus. In this example, Process 1 is associated with the processors coupled to FSB 1 of SMP 1, and Process 3 is associated with the processors of SMP 2, all of which are coupled to the single front side bus of SMP 2.

Following the decomposition of the application into multiple concurrent functional processes, the compiler next performs a data decomposition step to separate each functional process into multiple, parallel threads that each operate on different sets of data. As indicated in FIG. 1, because the data decomposed threads operate on different sets of data, the data decomposed threads are distributed among the processors coupled to a single front side bus. Thus, the threads 1 through N associated with Process 2 are distributed among processors CPU 1 through CPU N that are coupled to FSB 2 of SMP 1.

Although FIG. 1 depicts a computing environment that includes multiple symmetric multiple processors systems, the system and method of FIG. 1 could be employed in a computing environment that includes only one symmetric multiple processor system. In this environment, each set of processors that are coupled to a single front side bus would be considered a processing element, and the functional blocks would be distributed among the processing elements of the system. In this manner, the distribution of functional processes and data decomposed threads would be like the distribution of processes and threads to the processing elements of SMP 1 of FIG. 1.

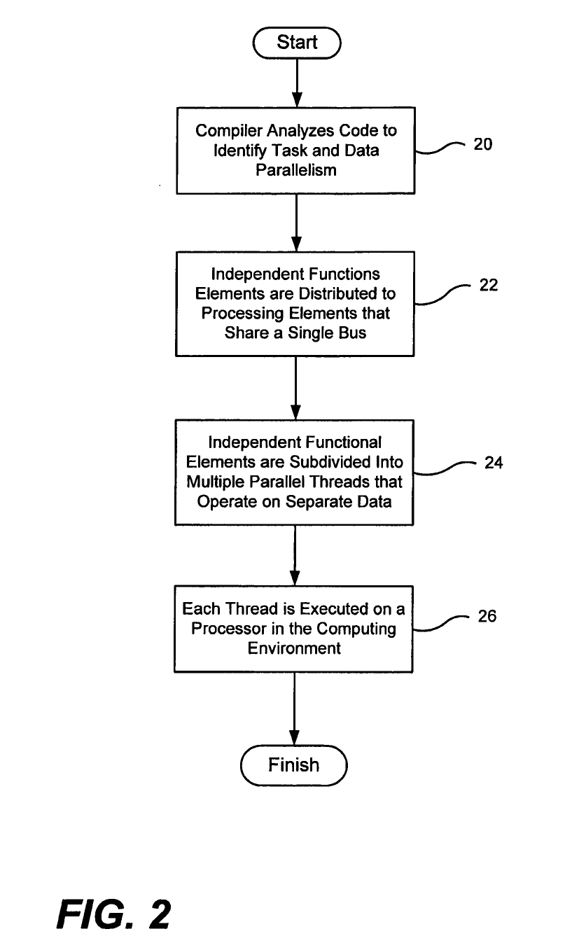

Shown in FIG. 2 is a flow diagram of the method steps for subdividing software code into a number of threads and distributing those threads for execution among the processors of the computing environment. At step 20, a compiler analyzes the software code to identify elements of the software code that can be separated according to principles of functional and data parallelism. As described above, the functional parallelism involves the separation of software into threads that comprise functional blocks. Data parallelism involves the separation of software into threads that operate on different sets of data. Following the analysis of software code on the basis of functional and data parallelism, independent functional elements are identified and distributed at step 22. Each functional element is distributed to processing element by a scheduler. A processing element is defined as one or more processors that share a single front side bus. At step 24, the independent functional elements are subdivided on a data decomposition basis into multiple, parallel threads that operate on separate data. Following the separation of the threads into data decomposed threads, the data decomposed threads are distributed to the individual processors within the computing environment.

Following the steps of FIG. 2, threads of the software code are separated on a functional basis, and the functionally separated threads are distributed among the processing elements of the computing environment. Thus, each functionally decomposed thread is placed with a different processing element in the computing environment. Because each functionally decomposed thread is placed for execution on a different processing element, conflict among the processing elements is minimized, as the necessity for one processing element to communicate with the resources of another processing element is reduced. Within each processing element, the functionally decomposed thread is further subdivided into a number of data decomposed threads, which are distributed among the individual processors of the processing element.

It should be recognized that the term software application is used herein to describe any form of software and should not be limited in its application to software code that executes on an operating system as a standalone application. Although the present disclosure has been described in detail, it should be understood that various changes, substitutions, and alterations can be made hereto without departing from the spirit and the scope of the invention as defined by the appended claims.

What is claimed is:

1. A method for executing a software application among the processors of a computing environment, comprising:
dividing the software applications into multiple functionally separate threads;
dividing each of the functionally separate threads into a number of sub-threads, wherein each of the subdivided sub-threads executes with a different set of data;
distributing the sub-threads among the processors of the computing environment, wherein each of the sub-threads associated with a functionally separate thread is distributed to a single processing element that includes a single front side bus.

2. The method for executing a software application among the processors of a computing environment of claim 1, further comprising the step of distributing the sub-threads associated with a functionally separate thread to each of the processors in the processing element.

3. The method for executing a software application among the processors of a computing environment of claim 1, wherein each processing element includes multiple processors coupled to a single front side bus.

4. The method for executing a software application among the processors of a computing environment of claim 1, wherein the functionally separate threads comprise asynchronous software functions.

5. The method for executing a software application among the processors of a computing environment of claim 1, wherein the dividing steps are performed by a compiler of the software application.

6. The method for executing a software application among the processors of a computing environment of claim 2,
wherein each processing element includes multiple processors coupled to a single front side bus;
wherein the functionally separate threads comprise asynchronous software functions; and
wherein the dividing steps are performed by a compiler of the software application.

7. A computing system, comprising:
a first processing element, wherein the first processing element includes multiple processors coupled to a first front side bus;
a second processing element, wherein the second processing element includes multiple processors coupled to a second front side bus;
a software application, wherein the threads of the software application are divided such that a first functionally decomposed thread of the software application executes on the processors of the first processing element, and wherein a second functionally decomposed thread of the software application executes on the processors of the second processing element.

8. The computing system of claim 7, wherein each functionally decomposed thread is further subdivided into multiple threads optimized to operate on different sets of data and wherein each of the subdivided threads are distributed for execution on one of the processors of the associated processing element.

9. The computing system of claim 7, wherein each functionally decomposed thread comprises asynchronous software functions.

10. The computing system of claim 7, further comprising a compiler for dividing the software application into multiple functionally decomposed threads.

11. The computing system of claim 7, further comprising a compiler for dividing the software application into multiple functionally decomposed threads, and wherein each functionally decomposed thread comprises asynchronous software functions.

12. The computing system of claim 8, wherein each functionally decomposed thread comprises asynchronous software functions.

13. The computing system of claim 8, further comprising a compiler for dividing the software application into multiple functionally decomposed threads.

14. The computing system of claim 8, further comprising a compiler for dividing the software application into multiple functionally decomposed threads, and wherein each functionally decomposed thread comprises asynchronous software functions.

15. A method for executing a software application among the processors of a computing environment, comprising:
dividing the software applications into multiple functionally separate threads;
dividing at least one of the functionally separate threads into multiple sub-threads, wherein each of the subdivided sub-threads executes with a different set of data;
distributing the sub-threads among the processors of the computing environment, wherein each of the sub-threads associated with a functionally separate thread is distributed to a single processing element that includes a single front side bus.

16. The method for executing a software application among the processors of a computing environment of claim 15, wherein the functionally separate threads comprise asynchronous software functions.

17. The method for executing a software application among the processors of a computing environment of claim 15, wherein the dividing steps are performed by a compiler of the software application.

18. The method for executing a software application among the processors of a computing environment of claim 15, further comprising the step of distributing the sub-threads associated with a functionally separate thread to each of the processors in the processing element.

19. The method for executing a software application among the processors of a computing environment of claim 18, wherein the functionally separate threads comprise asynchronous software functions.

20. The method for executing a software application among the processors of a computing environment of claim 18, wherein the dividing steps are performed by a compiler of the software application.
